(19) United States
(12) Patent Application Publication
(10) Pub. No.: US 2014/0295806 A1
(43) Pub. Date: Oct. 2, 2014

(54) ENCODED IDENTIFIER BASED NETWORK

(71) Applicant: DYL, LLC, Marina del Rey, CA (US)

(72) Inventor: Michael Kritikos Frager, Marina del Rey, CA (US)

(73) Assignee: DYL, LLC, Marina del Rey, CA (US)

(21) Appl. No.: 13/852,995

(22) Filed: Mar. 28, 2013

(51) Int. Cl. H04L 29/12; H04W 8/18

(52) U.S. Cl. CPC H04L 61/106; H04W 8/18
USPC 455/414.1

(57) ABSTRACT

An encoding process receives a request to subscribe to a subscription service. The request includes a subscriber identifier and an endpoint identifier. Further, the encoding process encodes the subscriber identifier into an encoded subscriber identifier. In addition, the encoding process sends the subscriber identifier, the encoded subscriber identifier, and the endpoint identifier to a host server. A routing process receives, at a host server, a request to establish communication with a subscriber identifier. Further, the routing process searches, at a database, for the subscriber identifier to determine a communication route corresponding to the subscriber identifier. The communication route includes an encoded subscriber endpoint identifier that is generated based upon an encoded subscriber identifier. The encoded subscriber identifier is encoded based upon the subscriber identifier.

### BACKGROUND

1. Field

This disclosure generally relates to the field of communication networks. More particularly, the disclosure relates to identifier based communication networks.

2. General Background

Current telephone networks allow users to communicate via various communication devices such as telephones. The public switched telephone network (“PSTN”) is a network of various cables, satellites, and the like that are interconnected via switching centers. A particular telephone has a telephone number associated with it so that a different telephone can call that telephone number to establish communication.

As PSTN network configurations require users to associate telephone numbers with particular telephone devices, users often have to remember or store telephone numbers that are not necessarily intuitive. In other words, a telephone number is not an identifier that is easily retained by a user as that of another user.

Further, users often have multiple communication devices. As developments in technology have allowed users to interact with each other through devices other than telephones, e.g., computing devices that allow for texting, instant messaging, video communications, video conferencing, and the like, a user may have to remember multiple identifiers for communicating with another user. For example, the other user may have multiple telephones that each has a different telephone number. As another example, the other user may have a telephone number, a social networking username, a video messaging identifier, and/or the like. The various communication capabilities have enhanced the variety of communication possibilities, but have provided an additional burden on users to maintain a larger set of data to access those communication possibilities.

### SUMMARY

In one aspect of the disclosure, a process is provided. The process receives a request to subscribe to a subscription service. The request includes a subscriber identifier and an endpoint identifier. Further, the process, encodes, with a processor, the subscriber identifier into an encoded subscriber identifier. In addition, the process sends the subscriber identifier, the encoded subscriber identifier, and the endpoint identifier to a host server.

In another aspect of the disclosure, a computer program product includes a computer useable medium having a computer readable program. The computer readable program when executed on a computer causes the computer to receive a request to subscribe to a subscription service. The request includes a subscriber identifier and an endpoint identifier. Further, the computer readable program when executed on the computer causes the computer to encode the subscriber identifier into an encoded subscriber identifier. In addition, the computer readable program when executed on the computer causes the computer to send the subscriber identifier, the encoded subscriber identifier, and the endpoint identifier to a host server.

In yet another aspect of the disclosure, an apparatus is provided. The apparatus comprises a computing device that receives a request to subscribe to a subscription service, encodes the subscriber identifier into an encoded subscriber identifier, and sends the subscriber identifier, the encoded subscriber identifier, and the endpoint identifier to a host server. The request includes a subscriber identifier and an endpoint identifier.

In another aspect of the disclosure, a process is provided. The process receives, at a host server, a request to establish communication with a subscriber identifier. Further, the process searches, at a database, for the subscriber identifier to determine a communication route corresponding to the subscriber identifier. The communication route includes an encoded subscriber endpoint identifier that is generated based upon an encoded subscriber identifier. The encoded subscriber identifier is encoded based upon the subscriber identifier.

In yet another aspect of the disclosure, a computer program product is provided. The computer readable program when executed on a computer causes the computer to receive, at a host server, a request to establish communication with a subscriber identifier. Further, the computer readable program when executed on the computer causes the computer to search, at a database, for the subscriber identifier to determine a communication route corresponding to the subscriber identifier. The communication route includes an encoded subscriber endpoint identifier that is generated based upon an encoded subscriber identifier. The encoded subscriber identifier is encoded based upon the subscriber identifier.

In another aspect of the disclosure, an apparatus is provided. The apparatus comprises a computing device that receives, at a host server, a request to establish communication with a subscriber identifier and searches, at a database, for the subscriber identifier to determine a communication route corresponding to the subscriber identifier. The communication route includes an encoded subscriber endpoint identifier that is generated based upon an encoded subscriber identifier. The encoded subscriber identifier is encoded based upon the subscriber identifier.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an encoding and routing system that is utilized to provide encoding of a subscriber identifier and routing of communications to a subscriber endpoint associated with the subscriber identifier.

FIG. 2 illustrates the components of the subscription network illustrated in FIG. 1.

FIG. 3 illustrates an example of a display that may be utilized for registration of a subscriber by the subscription server illustrated in FIG. 2.

FIG. 4 illustrates a process that may be utilized to perform the encoding.

FIG. 5 illustrates a process that may be utilized to perform the routing.

FIG. 6 illustrates a block diagram of a station or system that performs encoding and routing.

### DETAILED DESCRIPTION

A method, system, apparatus, and computer program product may be utilized to provide identifier encoding and communication routing based on an encoded identifier. As an example, a communications network may be established so that a subscription service is utilized to access the communications network. A subscriber to the communications network establishes a subscription by providing a subscriber identifier and an endpoint identifier. The term endpoint identifier is intended herein to mean an identifier at which communication may be established, e.g., a telephone number, a digital address, or the like. The communications network may then route future communications to that subscriber based upon the subscriber identifier and the endpoint identifier.

As an example, a first subscriber may select an e-mail address as a subscriber identifier and a telephone number as an endpoint identifier. A second subscriber may provide the e-mail address rather than the telephone number of the first subscriber to a communication device to establish communication with the first subscriber. As a result, the second subscriber may utilize the e-mail address of the first subscriber for multiple purposes, e.g., calling the first subscriber, e-mailing the first subscriber, or the like, without having to remember or store both an e-mail address and a telephone number.

A variety of other types of identifiers may also be utilized instead of an e-mail address. As an example, a social networking username may be utilized as the subscriber identifier along with a telephone number as the endpoint identifier. Accordingly, the first subscriber may provide the social networking identifier to the second subscriber so that the second subscriber may socially interact with the first subscriber, call the first subscriber, instant message the first subscriber, or the like, without having to remember both a social networking username and a telephone number.

As yet another example, a subscriber may select a uniform resource locator (“URL”) as a subscriber identifier and a telephone number as an endpoint identifier. For instance, the subscriber may be a business. That business may want to utilize the URL for its website as the subscriber identifier and a telephone number as the endpoint identifier. As a result, potential customers may utilize the URL for the website of the business to either access web content associated with the business or call the business. Accordingly, a potential customer does not have to search the Internet for the telephone number of the business as the URL for the website provides voice communication between the user and the business.

As another example, a subscriber may select a hashtag topic identifier as a subscriber identifier. Accordingly, users may communicate based on a common topic.

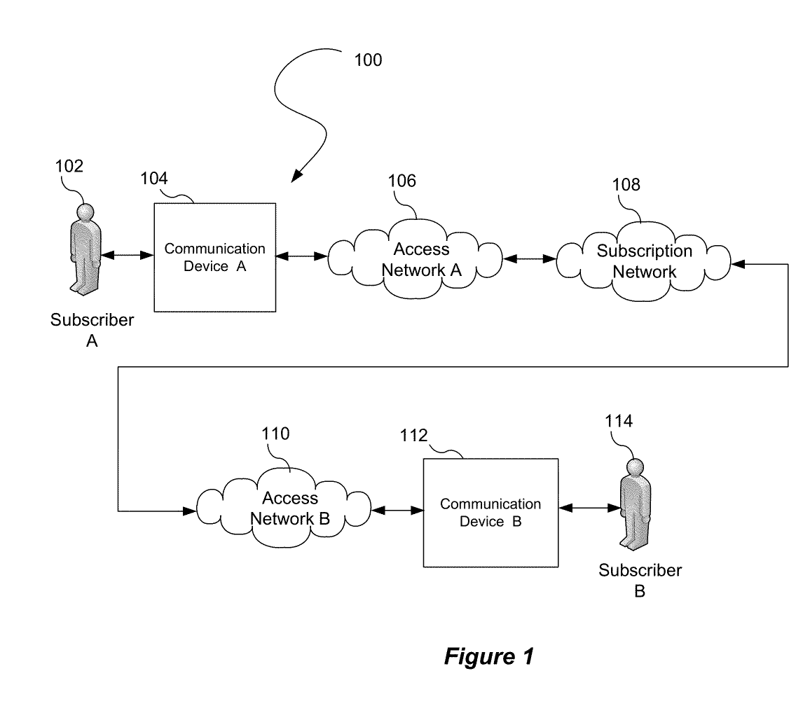

FIG. 1 illustrates an encoding and routing system 100 that is utilized to provide encoding of a subscriber identifier and routing of communications to a subscriber endpoint associated with the subscriber identifier. In one embodiment, the encoding and routing system 100 is implemented via a voice over internet protocol (“VoIP”) network. The VoIP network transmits and receives voice signals as data packets. A variety of other types of networks may be utilized for similar or different types of communications.

A subscriber A 102 utilizes a communication device A 104 to communicate with a subscriber B 114 that utilizes a communication device B 112. A communication device is herein intended to include any electronic device that is capable of exchanging voice, video, and/or text data with another electronic device through a communications network. Examples of communication devices include, but are not limited to, digital telephones, smartphones, cellular phones, personal computers, laptops, notebooks, tablet devices, and/or the like.

The communication device A 104 utilizes an access network A 106 to connect to the subscription network 108. The access network may include various types of connections to a carrier, e.g., telephone service provider. Examples of such connections include wireless, cable, satellite, PSTN, or the like. The carrier then connects to a subscription provider through the subscription network 108.

The subscription network 108 routes a communication initiated from the communication device A 104 to the communication device B 112. In one embodiment, the subscription network 108 utilizes a subscriber identifier of the subscriber B 114 that is provided by the subscriber A 102 to determine an endpoint identifier for the subscriber B 114. For example, the subscription provider associated with the subscription network 108 previously established a subscriber identifier and an endpoint identifier that is associated with the subscriber B 114. For instance, the subscriber identifier may be an e-mail of the subscriber B 114. The endpoint identifier may be a telephone number of a smartphone of the subscriber B 114. The subscriber B 114 only has to provide the subscriber A 102 with the subscriber identifier of the subscriber B 114 to allow the subscriber A 102 to initiate communications with the subscriber B 114. The subscription provider determines the endpoint identifier, e.g., the telephone number of the subscriber B 114, from the subscription of the subscriber B 114. The subscription network 108 may then route the telephone communication from the communication device A 104 to the communication device B 112 based upon the endpoint identifier, e.g., the telephone number. For example, the subscription network may provide the telephone number to an access network B 110 so that a carrier may then send the communication to the endpoint identifier for the subscriber B 114.

The encoding and routing system 100 allows for domain independent communications. In other words, the encoding and routing system 100 performs an encoding through the subscription network 108 for subscribers so that the subscriber identifier does not have to be from a particular domain. For example, the subscriber A 102 may have an e-mail address that has a first domain whereas the subscriber B 114 may have an e-mail address that has a second domain that is different from the first domain. Both subscribers are able to utilize the subscription service as the subscription network 108 encodes each of the e-mail addresses into an encoded subscriber identifier so that the e-mail addresses from different domains are in a format compatible with the particular communications network. In one embodiment, the subscribers are unaware of the encoded formats of the subscriber identifiers. For example, the subscribers may utilize their respective e-mail addresses as subscriber identifiers. The subscription network 108 may then utilize previously stored encoded subscriber identifiers associated with the subscriber identifiers. Alternatively, the encodings may be generated rather than being previously stored.

Further, the encoding and routing system 100 provides privacy for each subscriber because an endpoint identifier does not have to be provided to other users. For example, a subscriber may provide an e-mail address to another subscriber without having to provide a corresponding telephone number to that other subscriber. The subscription network 108 maintains the associations between the telephone numbers and e-mail addresses.

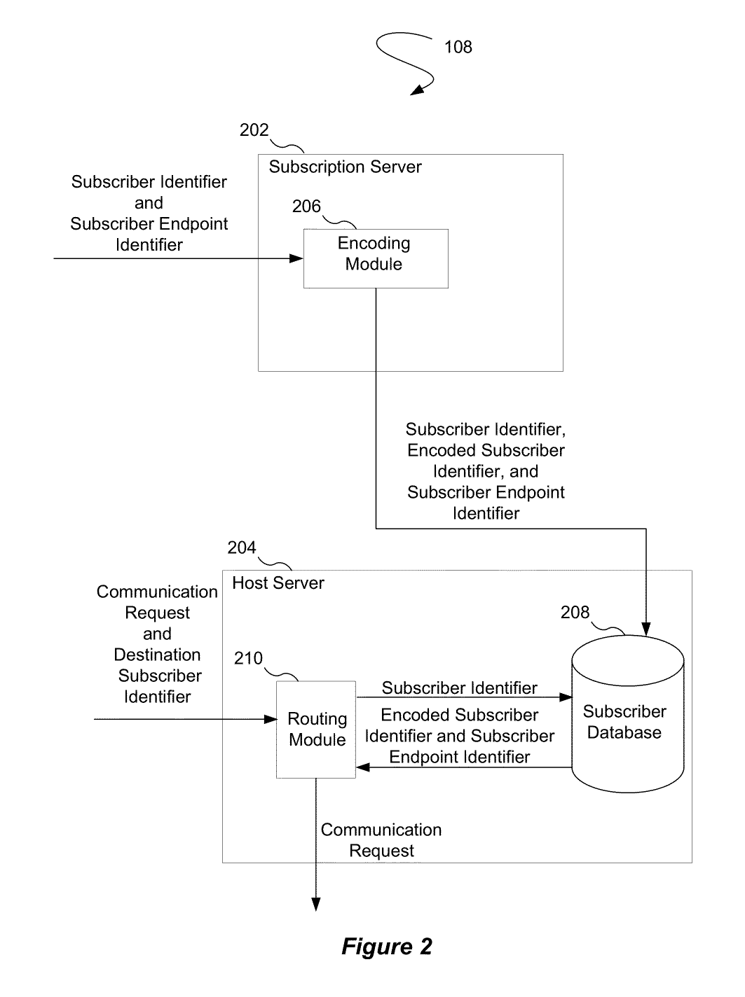

FIG. 2 illustrates the components of the subscription network 108 illustrated in FIG. 1. In one embodiment, the subscription network 108 includes a subscription server 202 and a host server 204. The subscription server 202 is utilized to register a subscriber, i.e., encode the subscriber identifier and associate the encoded subscriber identifier with a subscriber endpoint identifier. For example, a subscriber may provide an e-mail address and a telephone number for a smartphone of the subscriber. The subscription server 202 has an encoding module 206 that performs the encoding. A module as provided for herein is a processor, software, application, or the like. The encoding task may be performed by a single module or multiple modules. The encoding module 206 is provided for illustrative purposes.

The encoding module 206 receives a subscriber identifier and a subscription endpoint identifier from a subscriber during the registration process or during a subsequent update request. For example, the subscriber B 114 illustrated in FIG. 1 may want to provide the e-mail address person@anydomain.com as the subscriber identifier along with a telephone number for a smartphone as the subscriber endpoint identifier.

The encoding module 206 then encodes the subscriber identifier. For example, the encoding module 206 may encode the e-mail address of person@anydomain.com as person%40anydomain.com. In other words, the encoding module 206 encodes the subscriber identifier into an encoded subscriber identifier. In one embodiment, the encoding process utilizes the domain itself, e.g., anydomain.com, as part of the encoded subscriber identifier. In an alternative embodiment, the encoding may be performed without the domain itself.

In one embodiment, the encoding module 206 further generates an encoded subscriber endpoint identifier. The encoding module 206 adds a domain of the host server 204 or another server to the encoded subscriber identifier. For example, the encoding module 206 may add the domain of @host.com. As a result, the encoded subscriber endpoint identifier is person%40anydomain.com@host.com. The encoded subscriber endpoint identifier may be a URL, link, or the like. For example, the encoded subscriber endpoint identifier person%40anydomain.com@host.com may be a URL.

Although the encoding module 206 is described as performing both types of encoding, different modules may be utilized respectively to encode the subscriber identifier and generate a URL, link, or the like based upon the initial encoding.

In one embodiment, the subscription server 202 provides the subscriber identifier, the encoded subscriber identifier, the subscriber endpoint identifier, and/or the encoded subscriber endpoint identifier to a subscriber database 208 at the host server 204. The subscriber database 208 may be part of the host server 204 or distinct from host server 204. The subscriber database 208 is in operable communication, e.g., wireline, wireless, or the like, with the host server 204 if the subscriber database 208 is distinct from the subscriber database 208.

The host server 204 may then receive a communication request and a destination subscriber identifier. For example, the subscriber A 102 illustrated in FIG. 1 may want to establish communication with the subscriber B 114 illustrated in FIG. 1. Accordingly, the subscriber A 102 may initiate a communication request, e.g., providing an input to the communication device A 104 to initiate a communication. For example, the input may be a dial button on a smartphone. The destination subscriber identifier may be an e-mail address, e.g., anyperson@domain.com or other identifier for the subscriber B 114.

A routing module 210 at the host server 204 provides the subscriber identifier to the subscriber database 208 to determine the encoded subscriber identifier, the subscriber endpoint identifier, and/or the encoded subscriber endpoint identifier. As an example, the encoded subscriber endpoint identifier provides a digital route for the communication. Further, the subscriber endpoint identifier allows the routing module 210 to forward a communication intended for an encoded subscriber endpoint identifier to a particular subscriber endpoint identifier such as a telephone number.

Various types of protocols may be utilized for the communication routes. As an example, Session Initiation Protocol (“SIP”) is an Internet Protocol that may be utilized for VoIP communications. As a SIP address has a username and a domain name, the URL generated by the encoding module 206 may be utilized as a SIP address. For example, the host server 204 may be a SIP server. Accordingly, the initial encoding of the subscriber identifier, e.g., person$40anydomain.com, may be the username for the SIP address. Further, the domain name, e.g., @host.com, may be the domain name of the SIP address. Accordingly, the SIP address may be a SIP URL such as person%40anydomain.com@host.com.

SIP communications involve data being sent and received between different digital endpoints, e.g., SIP addresses. For example, a user with a SIP address of persona@siphost.com may communicate with a user with a SIP address of personb@siphost.com. In contrast with previous configurations that rely on users calling SIP addresses with telephones, the encoding and routing system 100 illustrated in FIG. 1 does not rely on users calling SIP addresses. Most telephone users simply do not utilize SIP addresses for telephone calls as they usually rely on telephone numbers associated with a telephone.

Further, previous configurations were domain reliant. In other words, SIP communication could not occur unless a domain administrator installed and configured a SIP host for a particular domain. For example, a user with an e-mail address of persona@domain.com could communicate with a user with an e-mail address of personb@domain.com. The user with the e-mail address of persona@domain.com would not be able to communicate with a user with an e-mail address of personb@differentdomain.com unless the domain administrator for differentdomain.com installed and configured a SIP host for that particular domain. Most domains simply do not have a SIP host. Further, many users are often provided with an e-mail address under a domain they do not control.

In contrast, the encoding and routing system 100 illustrated in FIG. 1 is domain independent. Accordingly, users with e-mail addresses with different domains may communicate with each other even if a particular domain does not have a SIP host. For example, the encoding module 206 illustrated in FIG. 2 generates a subscriber identifier of person%40domain.com@host.com for the first user and a subscriber identifier of person%40differentdomain.com@host.com for the second user. As a result, users with e-mail addresses having different domains may communicate with each other since the same SIP domain is generated as part of the encoding for both encoded subscriber identifiers. Accordingly, the encoding and routing system 100 illustrated in FIG. 1 may be utilized for digital to digital communications, e.g., smartphone to smartphone communications, utilizing a digital protocol such as SIP. Further, the encoding and routing system 100 illustrated in FIG. 1 may be utilized for digital to PSTN communications as the encoding and routing system allows a user to forward communications from an encoded subscriber endpoint identifier, e.g., SIP address, to a subscriber endpoint identifier, e.g., telephone number.

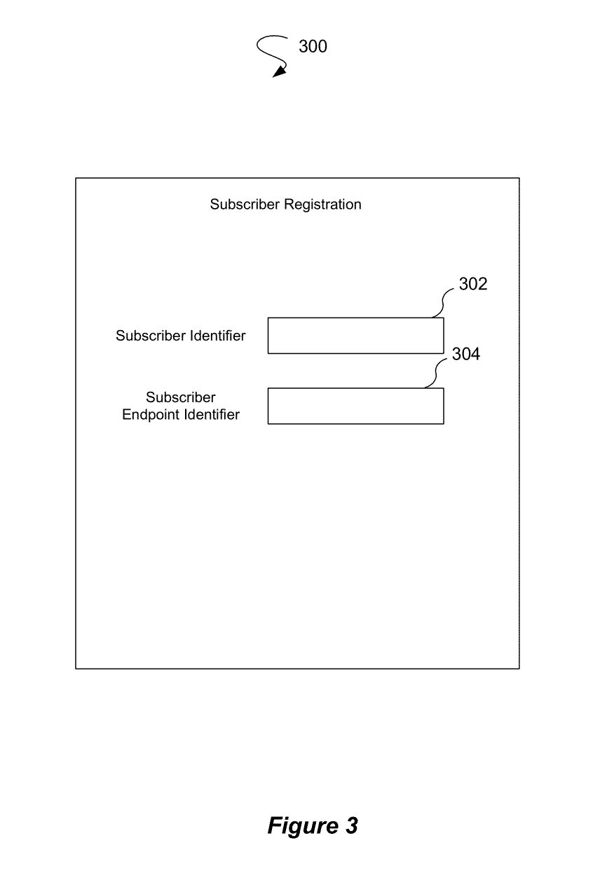

FIG. 3 illustrates an example of a display 300 that may be utilized for registration of a subscriber by the subscription server 202 illustrated in FIG. 2. As an example, the display 300 provides a subscriber identifier field 302 and a subscriber endpoint identifier field 304. Accordingly, the subscriber may utilize an e-mail address, social networking username, or the like for a subscriber identifier that is inputted into the subscriber identifier field 302. Further, the subscriber may utilize a telephone number for the subscriber endpoint identifier field 304. In one embodiment, the telephone number may be a digital telephone number, i.e., a telephone number from a smartphone. In another embodiment, the telephone number may be a PSTN telephone number.

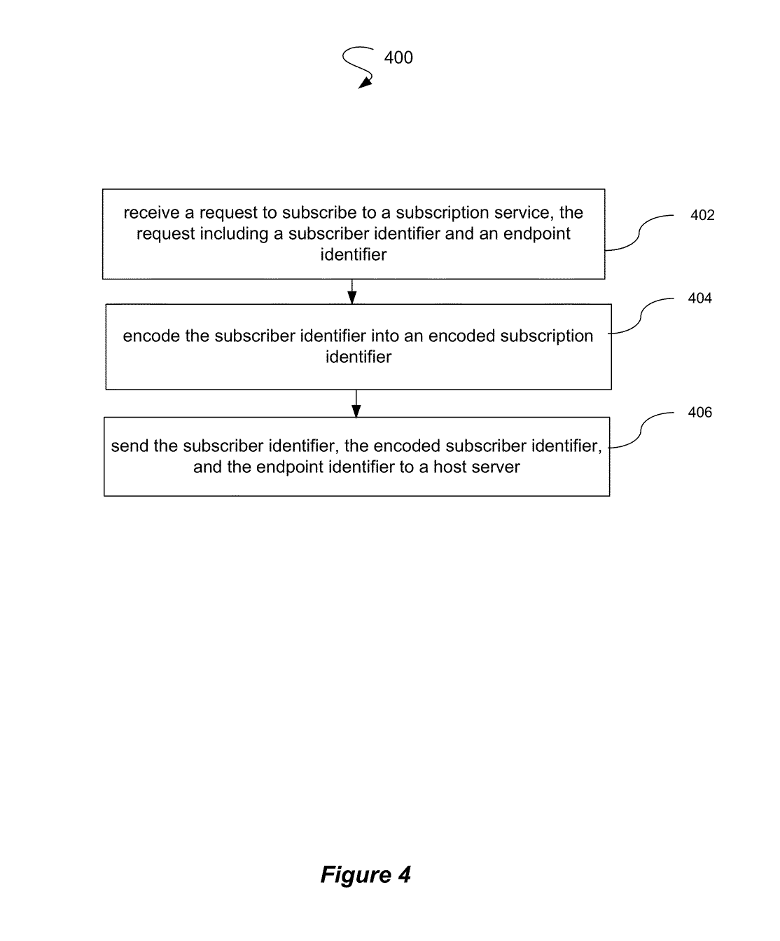

FIG. 4 illustrates a process 400 that may be utilized to perform the encoding. At a process block 402, the process 400 receives a request to subscribe to a subscription service. The request includes a subscriber identifier and an endpoint identifier. Further, at a process block 404, the process 400 encodes the subscriber identifier into an encoded subscriber identifier. In addition, at a process block 406, the process 400 sends the subscriber identifier, the encoded subscriber identifier, and the endpoint identifier to a host server. A processor may be utilized for the encoding and/or any other process component.

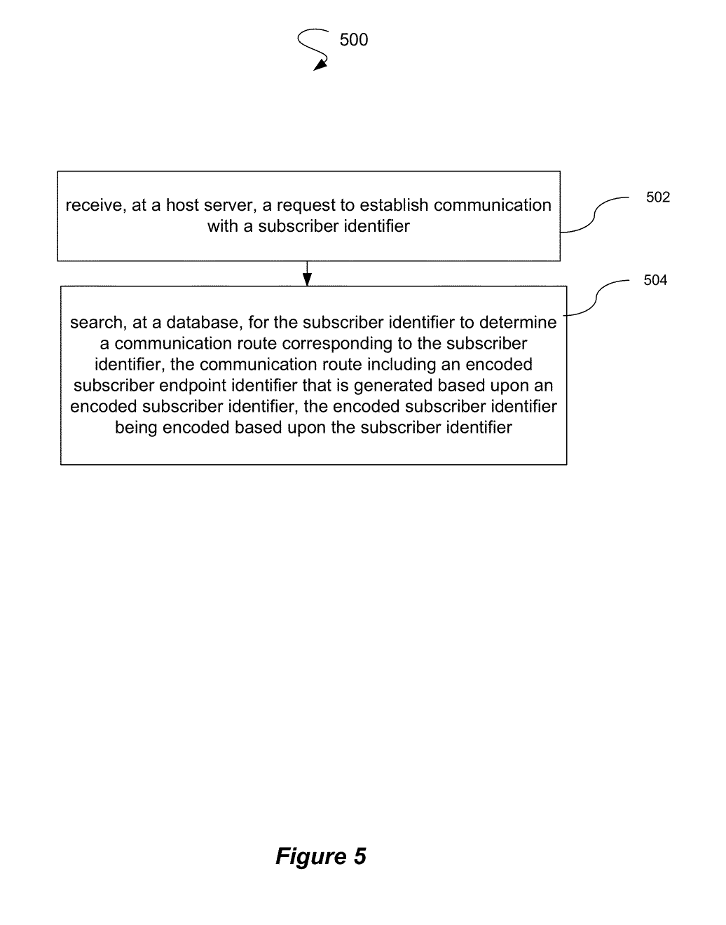

FIG. 5 illustrates a process 500 that may be utilized to perform the routing. At a process block 502, the process 500 receives, at a host server, a request to establish communication with a subscriber identifier. Further, at a process block 504, the process 500 searches, at a database, for the subscriber identifier to determine a communication route corresponding to the subscriber identifier. The communication route includes an encoded subscriber endpoint identifier that is generated based upon an encoded subscriber identifier. The encoded subscriber identifier is encoded based upon the subscriber identifier.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

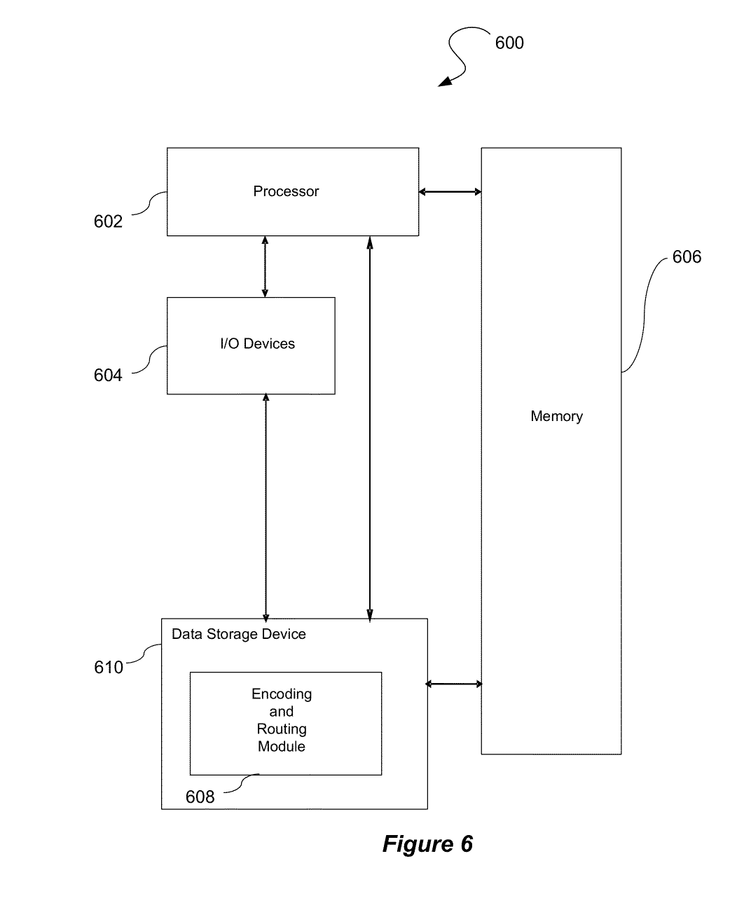

FIG. 6 illustrates a block diagram of a station or system 600 that performs encoding and routing. In one embodiment, the station or system 600 is implemented utilizing a general purpose computer or any other hardware equivalents. Thus, the station or system 600 comprises a processor 602, a memory 606, e.g., random access memory (“RAM”) and/or read only memory (ROM), an encoding and routing module 608, a data storage device 610 that stores the encoding and routing module 608, and various input/output devices 604, e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device such as a keyboard, a keypad, a mouse, and the like, or a microphone for capturing speech commands.

It should be understood that the encoding and routing module 608 may be implemented as one or more physical devices that are coupled to the processor 602. For example, the encoding and routing module 608 may include a plurality of modules. Alternatively, the encoding and routing module 608 may be represented by one or more software applications or a combination of software and hardware where the software is loaded from a storage medium such as a storage device, e.g., a magnetic or optical drive, diskette, or non-volatile memory and operated by the processor 602 in the memory 606 of the computer. As such, the encoding and routing module 608 and associated data structures of the present disclosure may be stored on a computer readable medium such as a computer readable storage device, e.g., RAM memory, magnetic or optical drive or diskette and the like.

The station or system 600 may be utilized to implement any of the configurations herein. For example, the processor 602 may be utilized to encode a subscriber identifier, establishing communication, searching for a route, or the like. In one embodiment, the encoding and routing module 608 is integrated as part of the processor 602.

Although a subscription service is described, the process, systems, apparatuses, and computer program products described herein may be utilized without any subscription. As an example, the subscription network 208 may be an encoding and/or routing service without any subscriptions. A registration process may be utilized. In one embodiment, a registration process is utilized for the encoding and/or routing service whereas a subscription service is utilized for enhanced features. In another embodiment, the subscription network 208 is utilized by users that are not subscribers or registrants to interact with users that are subscribers or registrants.

It is understood that the processes, systems, apparatuses, and compute program products described herein may also be applied in other types of processes, systems, apparatuses, and compute program products. Those skilled in the art will appreciate that the various adaptations and modifications of the embodiments of the processes, systems, apparatuses, and compute program products described herein may be configured without departing from the scope and spirit of the present processes and systems. Therefore, it is to be understood that, within the scope of the appended claims, the present processes, systems, apparatuses, and compute program products may be practiced other than as specifically described herein.

I claim:

1. A method comprising:
receiving a request to subscribe to a subscription service, the request including a subscriber identifier and an endpoint identifier;
encoding, with a processor, the subscriber identifier into an encoded subscriber identifier; and
sending the subscriber identifier, the encoded subscriber identifier, and the endpoint identifier to a host server.

2. The method of claim 1, further comprising encoding the encoded subscriber identifier into an encoded endpoint identifier.

3. The method of claim 2, further comprising sending the encoded endpoint identifier to the host server.

4. The method of claim 1, wherein the encoded endpoint identifier is a uniform resource locator.

5. The method of claim 4, wherein the uniform resource locator is a session initiation protocol address.

6. The method of claim 1, wherein the subscriber identifier is an e-mail address.

7. The method of claim 1, wherein the subscriber identifier is social networking username.

8. The method of claim 1, wherein the subscriber identifier is a uniform resource locator corresponding to a website address.

9. The method of claim 1, wherein the subscriber identifier is a hashtag topic identifier.

10. A computer program product comprising a computer useable medium having a computer readable program, wherein the computer readable program when executed on a computer causes the computer to:
receive a request to subscribe to a subscription service, the request including a subscriber identifier and an endpoint identifier;
encode the subscriber identifier into an encoded subscriber identifier; and
send the subscriber identifier, the encoded subscriber identifier, and the endpoint identifier to a host server.

11. The computer program product of claim 10, further comprising encoding the encoded subscriber identifier into an encoded endpoint identifier.

12. The computer program product of claim 11, further comprising sending the encoded endpoint identifier to the host server.

13. The computer program product of claim 10, wherein the encoded endpoint identifier is a uniform resource locator.

14. The computer program product of claim 13, wherein the uniform resource locator is a session initiation protocol address.

15. The computer program product of claim 10, wherein the subscriber identifier is an e-mail address.

16. The computer program product of claim 10, wherein the subscriber identifier is social networking username.

17. The computer program product of claim 10, wherein the subscriber identifier is a uniform resource locator corresponding to a website address.

18. The computer program product of claim 10, wherein the subscriber identifier is a hashtag topic identifier.

19. An apparatus comprising:
a computing device that receives a request to subscribe to a subscription service, encodes the subscriber identifier into an encoded subscriber identifier, and sends the subscriber identifier, the encoded subscriber identifier, and the endpoint identifier to a host server, the request including a subscriber identifier and an endpoint identifier.

20. A method comprising:
receiving, at a host server, a request to establish communication with a subscriber identifier;
searching, at a database, for the subscriber identifier to determine a communication route corresponding to the subscriber identifier, the communication route including an encoded subscriber endpoint identifier that is generated based upon an encoded subscriber identifier, the encoded subscriber identifier being encoded based upon the subscriber identifier.

21. The method of claim 20, further comprising establishing communication based upon communication route.

22. The method of claim 20, wherein the encoded endpoint identifier is a uniform resource locator.

23. The method of claim 22, wherein the uniform resource locator is a session initiation protocol address.

24. The method of claim 20, wherein the subscriber identifier is an e-mail address.

25. The method of claim 20, wherein the subscriber identifier is social networking username.

26. The method of claim 20, wherein the subscriber identifier is a uniform resource locator corresponding to a website address.

27. The method of claim 20, wherein the subscriber identifier is a hashtag topic identifier.

28. A computer program product comprising a computer useable medium having a computer readable program, wherein the computer readable program when executed on a computer causes the computer to:
receive, at a host server, a request to establish communication with a subscriber identifier; and
search, at a database, for the subscriber identifier to determine a communication route corresponding to the subscriber identifier, the communication route including an encoded subscriber endpoint identifier that is generated based upon an encoded subscriber identifier, the encoded subscriber identifier being encoded based upon the subscriber identifier.

29. The computer program product of claim 28, further comprising establishing communication based upon communication route.

30. The computer program product of claim 28, wherein the encoded endpoint identifier is a uniform resource locator.

31. The computer program product of claim 30, wherein the uniform resource locator is a session initiation protocol address.

32. The computer program product of claim 31, wherein the subscriber identifier is an e-mail address.

33. The computer program product of claim 31, wherein the subscriber identifier is social networking username.

34. The computer program product of claim 31, wherein the subscriber identifier is a uniform resource locator corresponding to a website address.

35. The computer program product of claim 31, wherein the subscriber identifier is a hashtag topic identifier.

36. An apparatus comprising:
a computing device that receives, at a host server, a request to establish communication with a subscriber identifier and searches, at a database, for the subscriber identifier to determine a communication route corresponding to the subscriber identifier, the communication route including an encoded subscriber endpoint identifier that is generated based upon an encoded subscriber identifier, the encoded subscriber identifier being encoded based upon the subscriber identifier
